(19) United States
(12) Patent Application Publication
(10) Pub. No.: US 2021/0222825 A1
(43) Pub. Date: Jul. 22, 2021

(54) ANTISLIP FIXTURE

(71) Applicant: Akanbou Company Ltd., Tokyo (JP)

(72) Inventor: Seiki MISHIMA, Tokyo (JP)

(73) Assignee: Akanbou Company Ltd., Tokyo (JP)

(21) Appl. No.: 16/308,474

(22) PCT Filed: Aug. 2, 2018
(86) PCT No.: PCT/JP2018/028958

§ 371 Date: Dec. 9, 2018

(30) Foreign Application Priority Data
Mar. 26, 2018 (JP) 2018-058296

(51) Int. Cl. F16M 13/02; A45F 3/14

(52) U.S. Cl. CPC F16M 13/02; A45F 3/14

(57) ABSTRACT

Provided is an anti-slip fixture capable of winding around various kinds of objects to be wound having different outer diameters and preventing the winding equipment from moving from the winding position to the side of floor surface or ground, even when the subjects to be wound has no supporting portion. The anti-slip fixture comprises a base, a belt, and a anti-slip member, wherein the belt is inserted in the anti-slip member, and wherein the base comprises (a) central portion, (b) a binding bar for attaching the binding end of the belt, and (c) a returning bar which is equipped on an opposite side of the binding bar; and the belt comprises (a) binding end, (b) a free end opposite to the binding end, (c) a holding surface, and (d) a bonded surface having a hook and loop fastener area on a surface opposite to the holding surface; and the anti-slip member comprises (a) an anti-slip surface, and (b) an opening for belt insertion through which the belt can be inserted.

### TECHNICAL FIELD

The present invention relates to and anti-slip fixture. In particular, the present invention relates to an anti-slip fixture to prevent winding equipment which is wound around a subject to be wound (such as a rod-like body) from being moved from its winding position by gravity.

### BACKGROUND ART

A holder for beverage container 70 as shown in FIGS. 15 to 17, for affixing a beverage container at any position of the rod-like body extending in a direction perpendicular or at any angle to a horizontal surface (floor surface or ground) is known.

The holder for beverage container 70 is mainly composed of winding tool 71 to wind the holder for beverage container 70 on the rod-like body 80 and storage device 72 to store beverage container 79, and storage device 72 is attached to winding tool 71.

Winding tool 71 is composed of flat base 73 and strip-shaped belt 74, and one end of belt 74 (binding end 74a) is connected to binding bar 76, which is equipped adjacent to central portion 75.

Belt 74 has contacting surface 74c that comes into contact with the rod-like body in a state where the holder for beverage container 70 is wound around the rod-like body 80 (see FIG. 15), and further has a bonded surface composed of first, a hook and loop fastener area 74e (hook-like raised surface or loop-like raised surface) and second, a hook and loop fastener area 74f (loop-like raised surface or hook-like raised surface) on an opposite side of contacting surface 74c (see FIG. 16).

The holder for beverage container 70 is wound around the rod-like body 80 as follows. As shown in FIG. 17, an end (free end 74b) opposite to binding end 74a of belt 74 is inserted into return slit 77 provided on the opposite side of binding bar 76 of base 73. Next, the inserted belt 74 is folded back to the side of bonded surface 74d of belt 74. Finally, the first hook and loop fastener area 74e and the second hook and loop fastener area 74f are bonded together.

The holder for beverage container 70 is wound around rod-like body 80 so that contacting surface 75a of central portion 75 of base 73 and contacting surface 74c of belt 74 surround rod-like body 80.

### SUMMARY OF INVENTION

### Technical Problem

When the beverage container contained in the holder for beverage container 70 becomes heavy due to the amount of the beverage and, in particular, the rod-like body extends in the direction perpendicular to the horizontal surface, there is a drawback that the holder for beverage container 70 moves by gravity from the position wound around the rod-like body 80 to the side of floor surface or ground, as shown in FIG. 17.

In order to solve such a drawback, the holder for beverage container 70 may be attached to the upper side of supporting portion 81 with respect to the rod-shaped body 80 equipped with supporting portion 81, as shown in FIG. 17. However, it is limited to the case of attaching the holder for beverage container 70 to the rod-like body 80 with the support portion 81. Therefore, in the case of attaching the holder for beverage container 70 to the rod-like body without the supporting portion, the above-mentioned drawback is still unresolved.

With the aim of solving the aforementioned drawback, the present inventor has conducted intensive studies and as a result has successfully developed an anti-slip fixture that can be wound around various kinds of objects to be wound (such as rod-like bodies) having different outer diameters. Furthermore, in the anti-slip fixture, even when the subjects to be wound has no supporting portion, it is possible to prevent the winding equipment from moving from the winding position to the side of floor surface or ground, by gravity.

### Solution to Problem

The object can be solved by the antislip fixture of the present invention, i.e. an anti-slip fixture comprising a base, a belt, and an anti-slip member, wherein the belt is inserted into the anti-slip member, characterized in that

the base comprises
(1) a central portion comprising a holding surface, which is brought into direct or indirect contact with an object to be wound in a winding state, and a mounting surface for mounting a mounted equipment,
(2) a binding bar which is equipped adjacent to the central portion via a binding slit, for attaching the binding end of the belt, and
(3) a returning bar, which is equipped adjacent to the central portion via a returning slit on an opposite side of the binding bar,
the belt comprises
(1) a binding end attached to the binding bar of the base,
(2) a free end opposite to the binding end,
(3) a holding surface located on a surface side of the object to be wound in a winding state, and
(4) a bonded surface having a hook and loop fastener area on a surface opposite to the holding surface, and
the anti-slip member comprises
(1) an anti-slip surface which is brought into direct or indirect contact with the object to be wound in a winding state, and
(2) an opening for belt insertion through which the belt can be inserted.

According to a preferable embodiment of the anti-slip fixture of the present invention, the anti-slip fixture further comprises an anti-slip part on the holding surface of the base.

### Advantageous Effects of Invention

The anti-slip fixture of the present invention can be wound around various kinds of objects to be wound (such as rod-like bodies) having different outer diameters. Further, in the anti-slip fixture, even when the subjects to be wound has no supporting portion, it is possible to prevent the winding equipment from moving from the winding position to the side of floor surface or ground, by gravity.

### BRIEF DESCRIPTION OF THE DRAWINGS

FIG. 1 is a diagrammatic perspective view showing a state in which the mounted equipment is attached to the anti-slip fixture of the present invention.

FIG. 2 is a diagrammatic perspective view of winding equipment in a state in which only the belt is rotated by 180 degrees around the binding bar of the base, which is a rotation center, from the state shown in FIG. 1

FIG. 3 is a diagrammatic perspective view and a front view showing an embodiment of the anti-slip member.

FIG. 4 is a diagrammatic perspective view showing a state in which the winding equipment shown in FIG. 1 is being wound around the subject to be wound.

FIG. 5 is a front view showing a state in which the winding equipment 10 shown in FIG. 1 is wound around a rod-like body having a large outer diameter.

FIG. 6 is a front view showing a state in which the winding equipment 10 shown in FIG. 1 is wound around a rod-like body having a small outer diameter.

FIG. 7 are diagrammatic perspective views showing another embodiment of the anti-slip member.

FIG. 8 is a schematic sectional side view showing a state of bonding the first hook and loop fastener area and the second hook and loop fastener area in the case that a lateral surface of a third guide is brought close to a supporting surface of the plate.

FIG. 9 is a diagrammatic perspective view showing an anti-slip member having a movable bridge type guide and a method for attaching the anti-slip member to the belt.

FIG. 10 is a diagrammatic perspective view showing one embodiment of the unlinked type guide.

FIG. 11 is a diagrammatic perspective view showing one embodiment of a movable bridge type guide having locking means.

FIG. 12 is a diagrammatic perspective view showing another embodiment of the anti-slip fixture of the present invention.

FIG. 13 is an explanatory view of a method for shortening the belt in the anti-slip fixture of the present invention.

FIG. 14 is an explanatory view of a method for shortening the belt in the anti-slip fixture of the present invention.

FIG. 15 is a diagrammatic perspective view showing a conventional holder for a beverage container.

FIG. 16 is a diagrammatic perspective view of the winding equipment in a state in which only the belt is rotated by 180 degrees around the binding bar of the base which is a rotation center, from the state shown in FIG. 13.

FIG. 17 is an explanatory view showing a method for using the conventional holder for beverage container.

### DESCRIPTION OF EMBODIMENTS

Hereinafter, representative embodiments of the anti-slip fixture of the present invention will be illustrated with reference to the attached figures, but the present invention is not limited to the embodiments shown in the attached figures below.

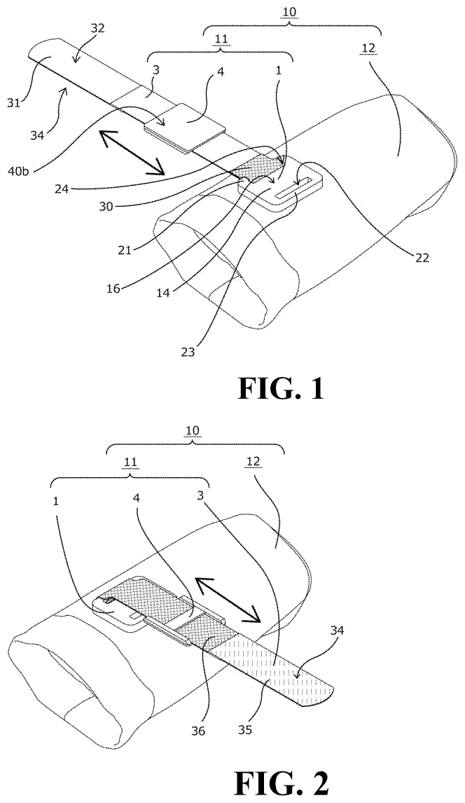

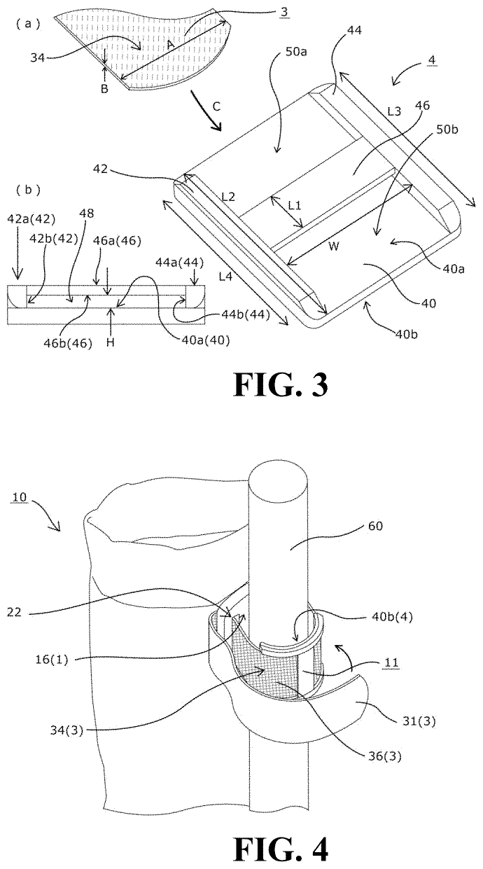

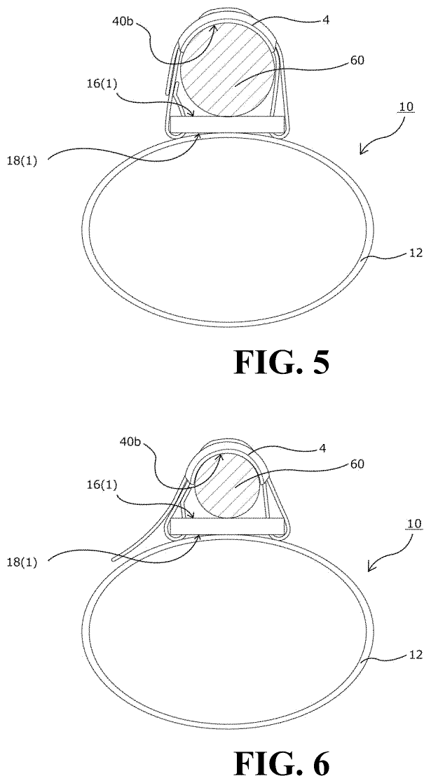

FIG. 1 is a diagrammatic perspective view showing a state in which the mounted equipment 12 is attached to the anti-slip fixture 11 of the present invention, to obtain the winding equipment 10, and FIG. 2 is a diagrammatic perspective view of the winding equipment 10 in a state in which only the belt 3 is rotated by 180 degrees around the binding bar 21 of the base 1 which is a rotation center, from the state shown in FIG. 1. Further, FIG. 3(a) is a diagrammatic perspective view of the anti-slip member 4 used in the anti-slip fixture 11 of the present invention, and FIG. 3(b) is a front view of the anti-slip member 4 used in the anti-slip fixture 11 of the present invention. Furthermore, FIG. 4 is a diagrammatic perspective view showing a state in which the winding equipment 10 shown in FIG. 1 is being wound around subject to be wound 60 (such as a rod-like body), FIG. 5 is a front view showing a state in which the winding equipment 10 shown in FIG. 1 is wound around a rod-like body 60 having a large outer diameter, and FIG. 6 is a front view showing a state in which the winding equipment 10 shown in FIG. 1 is wound around a rod-like body 60 having a small outer diameter.

The anti-slip fixture 11 of the present invention of the embodiment shown in FIGS. 1 to 6 comprises the base 1, the belt 3 and the anti-slip member 4. The belt 3 can be inserted through the anti-slip member 4. Further, after insertion, the anti-slip member 4 can be slid along the belt 3.

The base 1 comprises the central portion 14, the binding bar 21, and the returning bar 23. The shape of the base 1 is typically a roughly rectangular plate or a roughly square plate, and may be a roughly circular plate, or a roughly elliptical plate.

The central portion 14 has the holding surface 16 which is a surface on a side of the subject to be wound 60 in the winding state shown in FIGS. 5 and 6, and the mounting surface 18 to mount the fixture 12 on a surface opposite to the holding surface 16.

The binding bar 21 is equipped adjacent to the central portion 14 via the binding slit 24. The returning bar 23 is equipped adjacent to the central portion 14 via the returning slit 22 on the side opposite to the binding bar 21.

The binding end 30 of belt 3 is attached to the binding bar 21. The binding end 30 of the belt 3 can be attached to the binding bar 21 by the known methods.

For example, the end portion of the belt 3 before connection is passed through the binding slit and folded back to form a cylindrical body. Then, it can be attached by thermally fusing the folded end portion in a state in which the binding bar 21 is inserted into the cylindrical body. By this method, the binding end 30 of the belt 3 is rotatable relative to the binding bar 21.

The belt 3 is, for example, a strip-shaped member made of a soft material or a fibrous material. The belt 3 has the binding end 30 to be attached to the binding bar 21, a free end 31 which is an end opposite to the binding end 30, a holding surface 32, and a bonded surface 34.

In the winding state shown in FIGS. 5 and 6, the holding surface 32 is a surface on the side of the subject to be wound 60. The bonded surface 34 is a surface opposite to the holding surface 32, and has the first hook and loop fastener area 35 and the second hook and loop fastener area 36. The first hook and loop fastener area 35 (hook-like raised surface or loop-like raised surface) and the second hook and loop fastener area 36 (loop-like raised surface or hook-like raised surface) can be bonded to each other. As for the bonding force in bonding, the bonding force of known surface fasteners is sufficiently satisfied.

The joint surface 34 may have a combination type of the hook-like raised surface and the loop-like raised surface as the hook and loop fastener, but may have a type in which the hook-like raised surface and the loop-like raised surface are undistinguishable.

The anti-slip member 4 comprises a plate 40, a first guide 42, a second guide 44, and a third guide 46, as shown in FIG. 3.

The plate 40 has a supporting surface 40a for carrying the first guide 42 and the second guide 44, and an anti-slip surface 40b on the opposite side of the supporting surface 40a. The shape of the plate 40 is typically a roughly rectangular plate or a roughly square plate, and may be a roughly circular plate, or a roughly elliptical plate.

The first guide 42 and the second guide 44 regulate the movement of the anti-slip member 4 in the width direction of the belt 3 [the distance indicated by the arrow A in FIG. 3(a)], and the third guide 46 and the plate 40 regulate the movement of the belt 3 in the thickness direction [the distance indicated by the arrow B in FIG. 3(a)]

The first guide 42 and the second guide 44 are arranged on the supporting surface 40a of the plate 40 in parallel with the direction in which the belt 3 is inserted (insertion direction C).

The third guide 46 is a non-movable bridge type guide, and does not have an after-mentioned cut. The third guide 46 is arranged between the first guide 42 and the second guide 44 so as to bridge a non-movable bridge.

The first guide 42 and the second guide 44 can mainly facilitate an insertion work of the belt 3 into the anti-slip member 4, and the third guide 46 can mainly maintain an integration of the belt 3 and the anti-slip member 4.

Typically, the shape of the first guide 42 or the second guide 44 is a roughly quadrangular prism, and may be a roughly triangular prism, a roughly circular column, or a roughly elliptical column.

Typically, the shape of the third guide 46 is a roughly rectangular plate or a roughly square plate, and it may be a roughly quadrangular prism, a roughly prismatic column, a roughly cylindrical column, or a roughly elliptical column.

As shown in FIG. 3(a), the length of the third guide 46 in the insertion direction [the distance indicated by the arrow L1 in FIG. 3(a)] can be made shorter than the respective lengths of the first guide 42 in the insertion direction [the distance indicated by the arrow L2 in FIG. 3 (a)] and the second guide 44 in the insertion direction [the distance indicated by the arrow L3 in FIG. 3(a)]. That is to say, when the outer shape of the first guide 42, the second guide 44, and the third guide 46 is observed from the side of the supporting surface 40a of the plate 40, it can be H-shaped.

In the case of the H shape as shown in FIG. 3(a), an upstream exposure opening 50a and a downstream exposure opening 50b may be provided respectively on the upstream and the downstream in the insertion direction of the third guide 46. In a state where the belt 3 is inserted as shown in FIGS. 2 and 4, the bonded surface 34 of the belt 3 can be exposed from the anti-slip member 4 by the upstream exposure opening 50a and the downstream exposure opening 50b. As a result, as shown in FIG. 4, the bonded area of the first hook and loop fastener area 35 and the second hook and loop fastener area 36 does not decrease significantly in the anti-slip member 4. Thus, the bonding force between the first hook and loop fastener area 35 and the second hook and loop fastener area 36 is not greatly reduced in a state where the winding equipment 10 is wound around the subject to be wound 60.

The length of the third guide 46 in the insertion direction (L1) can be made substantially the same as the length of the first guide 42 in the insertion direction (L2) and the length of the second guide 44 in the insertion direction (L3). That is, it is also possible not to provide the upstream exposure opening 50a and the downstream exposure opening 50b. The outer shape of the first guide 42, the second guide 44, and the third guide 46 can be made roughly rectangular plate or roughly square plate when observing from a side of the supporting surface 40a of the plate 40.

The lateral surface 42a of the first guide 42, the lateral surface 44a of the second guide 44, and the lateral surface 46a of the third guide 46 may be flush with each other, as shown in FIG. 3(b). The lateral surface 46a of the third guide 46 can be brought closer to a side of the supporting surface 40a of the plate 40 than the lateral surface 42a of the first guide 42 and the lateral surface 44a of the second guide 44, as described later.

An opening for belt insertion 48 can be formed by the supporting surface 40a of the plate 40, a guide surface 42b of the first guide 42, an internal surface 46b of the third guide 46, and a guide surface 44b of the second guide 44.

The belt 3 and the anti-slip member 4 can be integrated by inserting the belt 3 through the opening for belt insertion 48.

It is possible to improve the insertion work of the belt 3 into the opening for belt insertion 48 and to improve the insertion condition between the opening for belt insertion 48 and the belt 3, by appropriately adjusting the distance between the internal surface 46b of the third guide 46 and the supporting surface 40a of the plate 40 [the distance indicated by the arrow H in FIG. 3(b)], and/or the distance between the guide surface 42b of the first guide 42 and the guide surface 44b of the second guide 44 [the distance indicated by the arrow W in FIG. 3(a)].

The entire anti-slip member 4 (or at least the plate 40 thereof), is made of an elastic, deformable soft material (same material used as a conventional non-slip means). Specifically, it is an elastomer (for example, thermoplastic elastomer), silicon, rubber material (for example, synthetic rubber), or urethane.

The elastic, deformable soft material (which is the same material used as a conventional non-slip means) is used only on the anti-slip surface 40b of the plate 40, and on the other parts, elastic, deformable soft material (which is a material different from one used as a conventional non-slip means) may be used.

The anti-slip member 4 can be formed, for example, by integral molding. Alternatively, it can be obtained by integrally molding the first guide 42, the second guide 44, and the third guide 46 in advance and attaching them to the plate 40.

The winding equipment 10 comprising the anti-slip fixture 11 of the present invention can be wound around the subject to be wound 60 by the following method. As shown in FIG. 4, the free end 31 of the belt 3 is inserted into the returning slit 22 of the base 1 so as to sandwich the subject to be wound 60 between the holding surface 16 of the base 1 and the anti-slip surface 40b of the anti-slip member 4. Then, the inserted belt 3 is folded back to a side of the bonding surface 34 of the belt 3, and finally the first hook and loop fastener area 35 and the second hook and loop fastener area 36 are bonded to each other.

The anti-slip member 4 is slidable along the longitudinal direction of the belt 3. Thus, as shown in FIGS. 5 and 6, according to the outer diameter of the rod-like body which is the subject to be wound 60, the anti-slip member 4 is appropriately moved so that the rod-like body can be sandwiched between the holding surface 16 of the base 1 and the anti-slip surface 40b of the anti-slip member 4.

The anti-slip member 4 is made of the elastic, deformable soft material, and therefore, when the winding equipment 10 is wound around various rod-like bodies, the entire anti-slip surface 40b of the plate 40 can be brought into contact with the surface of the rod-like bodies.

It is possible to prevent the winding equipment from moving from the winding position to the side of floor surface or ground, by sandwiching the rod-like body between the holding surface 16 of the base 1 and the anti-slip surface 40b of the anti-slip member 4, and bringing the entire surface of the anti-slip surface 40b of the plate 40 into contact with the surface of the rod-like body.

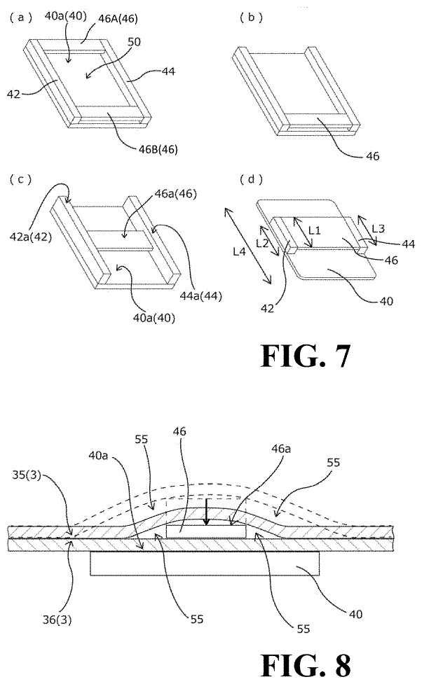

FIG. 7 shows another embodiment of anti-slip member 4.

As shown in FIG. 7(a), two third guides 46 can be used in the anti-slip member 4 shown in FIG. 3, in particular, one third guide 46A may be arranged at the end portion on the upstream with respect to the insertion direction, and the other third guide 46B may be arranged at the end portion of the downstream with respect to the insertion direction. In this case, a belt-exposing opening (belt-exposing central opening) 50 is formed between the third guide 46A and the third guide 46B. The outer shape of the first guide 42, the second guide 44, and the third guide 46 can be formed into a rectangular frame shape when observed from a side of the supporting surface 40 of the plate 40.

Further, as shown in FIG. 7(b), the third guide 46 can be arranged at the end portion on the downstream, in the anti-slip member 4 shown in FIG. 3. The outer shape of the first guide 42, the second guide 44, and the third guide 46 can be formed into a roughly U shape when observed from a side of the supporting surface 40a of the plate 40. Furthermore, the third guide 46 may be arranged at the end portion on the upstream.

Furthermore, as shown in FIG. 7(c), the lateral surface 46a of the third guide 46 can be located closer to the supporting surface 40a of the plate 40 than the lateral surface 42a of the first guide 42 and the lateral surface 44a of the second guide 44, in the anti-slip member 4 shown in FIG. 3. As shown in FIG. 8, it is possible to reduce an area of non-bonded regions 55 on the upstream and the downstream of the third guide 46, which are formed when the first hook and loop fastener area 35 and the second hook and loop fastener area 36 are bonded to each other, by bringing the lateral surface 46a of the third guide 46 closer to the side of the supporting surface 40a of the plate 40.

As shown in FIG. 7(d), the length of the third guide 46 in the insertion direction (L1), the length of the first guide 42 in the insertion direction (L2), and the length of the second guide 44 in the insertion direction (L3) can be made identical to each other, and as a result, each of these lengths can be made shorter than the length of the plate 40 in the insertion direction (L4). The outer shape of the first guide 42, the second guide 44, and the third guide 46 is I-shape when observed from the side of the supporting surface 40a of the plate 40.

The number of the third guide 46 and an arranged position of the third guide 46 can be arbitrarily selected as long as the bonding force between the first hook and loop fastener area 35 and the second hook and loop fastener area 36 of the belt 3 is not greatly reduced.

Further, the respective ratios of the length of the third guide 46 in the insertion direction (L1), the length of the first guide 42 in the insertion direction (L2), the length of the second guide 44 in the insertion direction (L3), and the length of the plate 40 in the insertion direction (L4) can be selected arbitrarily.

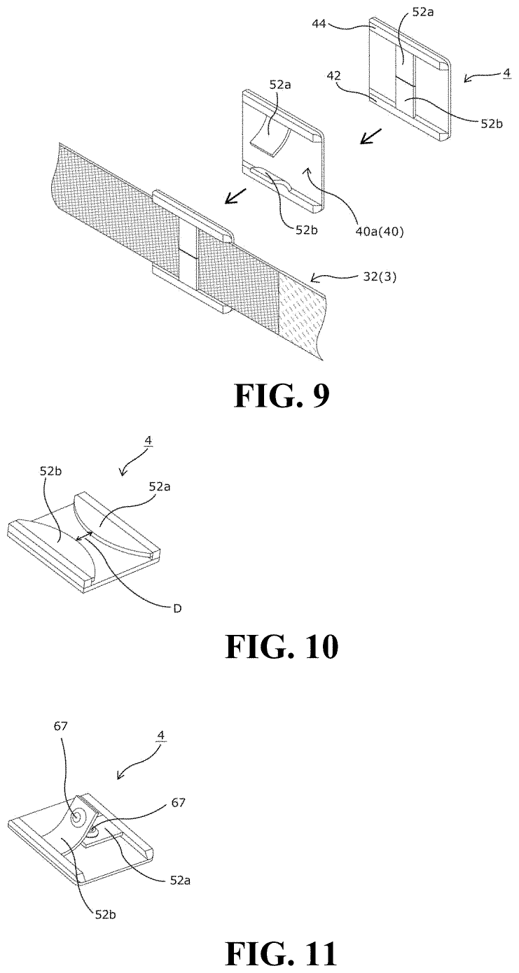

As shown in FIG. 9, the non-movable bridge type guide, i.e. the third guide 46 in the anti-skid device 4 shown in FIG. 3(a) can be cut. In this case, the third guide 46 is a movable bridge type guide having a first bridge 52a and a second bridge 52b, and is arranged so as to form a movable bridge between the first guide 42 and the second guide 44. In the above cut, the first bridge 52a and the second bridge 52b are substantially contactable, and does not have a clear space between the first bridge 52a and the second bridge 52b.

In all anti-slip members illustrated in FIGS. 1 to 8, the movable bridge type guide can be adopted as the third guide 46.

As shown in FIG. 9, the operation of attaching the anti-slip member 4 having the movable bridge type guide to the belt 3 can be performed as follows. Firstly, the first bridge 52a and the second bridge 52b are opened in a direction opposite to the supporting surface 40a of the plate 40. Next, in a state where the first bridge 52a and the second bridge 52b are opened, the anti-slip member 4 is brought close to the belt 3. Finally, after bringing the supporting surface 40a of the plate 40 into contact with the holding surface 32 of the belt 3, the open state of the first bridge 52a and the second bridge 52b is released.

Even when the third guide 46 is the movable bridge type guide, the anti-slip member is covered with the belt from the upper side thereof, as shown in FIG. 4. Therefore, in the winding state, the anti-slip member 4 having the movable bridge type guide is not detached from the belt 3.

As shown in FIG. 10, in the movable bridge type guide as the third guide 46, the shapes of the first bridge 52a and the second bridge 52b may be semicircular.

In this case, as shown in FIG. 10, a space [the distance indicated by the arrow D in FIG. 10] can be provided between the first bridge 52a and the second bridge 52b, so that they are not brought into contact with each other. The third guide 46 can be an unlinked type guide in which the first bridge 52a and the second bridge 52h are not connected to each other. In the all anti-slip members, the third guides 46 can be the unlinked type guides.

Needless to say, the first bridge 52a and the second bridge 52b may be brought into contact with each other in the embodiment shown in FIG. 10, as in the case of the movable bridge type guide.

As shown in FIG. 11, in the movable bridge type guide, a locking means 67 (for example, a button) or a bonding means (for example, a hook and loop fastener) is attached to one lateral surface and the other internal surface in the first bridge 52a and the second bridge 52b by known methods. The locking means 67 or the bonding means can be attached thereto, by appropriately changing the length (in the direction perpendicular to the insertion direction) of the first bridge 52a and/or the second bridge 52b.

It is possible to prevent the anti-slip member 4 comprising the movable bridge type guide from being detached from the belt 3 by attaching these means, even if it is not in the winding state.

As another embodiment of the anti-slip member, an anti-slip member using only the plate 40 (flat type anti-slip member) can be used, in particular, an anti-slip member, which does not have the first guide, the second guide, and the third guide, can be used.

In this embodiment, the belt and the anti-slip member 4 can be integrated by providing the openings for belt insertion on the upstream and the downstream of the plate respectively. For example, at the upstream opening for belt insertion, the free end of the belt is inserted from the anti-slip surface of the plate to the supporting surface. Next, at the downstream opening for belt insertion, the free end of the belt is inserted from the supporting surface of the plate to the anti-slip surface, and thereby, finally, the belt and the anti-slip member can be integrated.

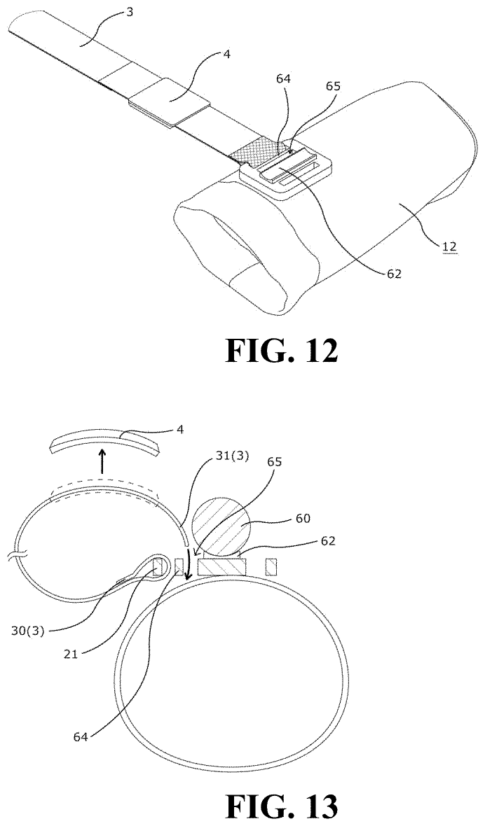

As shown in FIG. 12, an anti-slip part 62 can be equipped on the holding surface 16 of the central portion 14 of the base 1. The anti-slip part 62 can be made of an elastic, deformable soft material (which is the same material used as a conventional non-slip means). Specifically, it is an elastomer (for example, thermoplastic elastomer), silicon, rubber material (for example, synthetic rubber), or urethane.

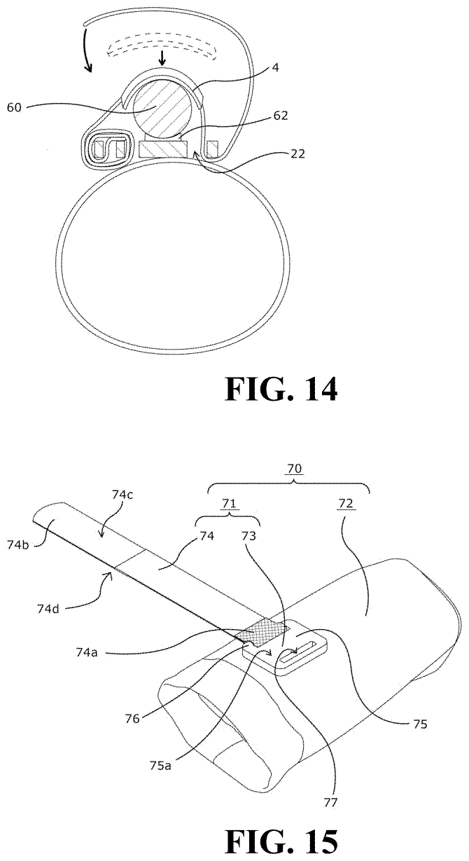

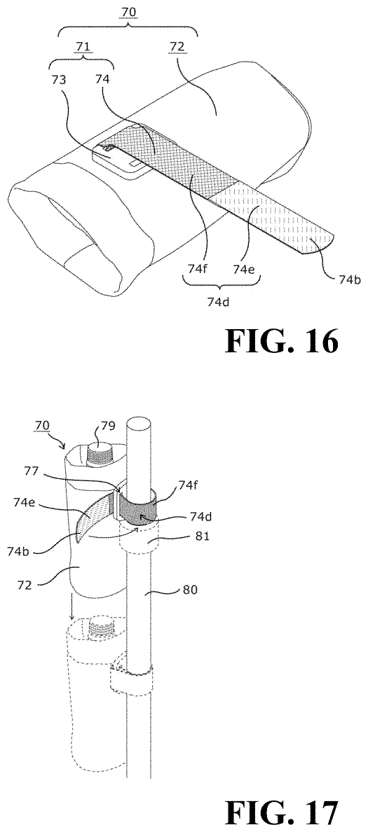

As shown in FIG. 14, the rod-like body which is the subject to be wound 60 is sandwiched between the anti-slip member 4 and the anti-slip part 62 by providing the anti-slip member 62, and thus the winding equipment 10 can be firmly wound around the subject to be wound.

In addition, as shown in FIG. 12, a winding bar 64 and a winding slit 65 may be equipped between the central portion 14 and the binding bar 21. The number of winding bars 64 and the number of winding slits 65 are not particularly limited.

As shown in FIG. 13, for example, when the outer diameter of the rod-like body which is the subject to be wound 60 is extremely small, firstly, the free end 31 of the belt 3 is inserted into the winding slit 65 once or a plurality of times according to the outer diameter of the subject to be wound, so that the binding end 30 of the belt 3 is wound around the binding bar 21 and the winding bar 64 once or a plurality of times. This makes it possible to shorten the length of the belt 3 in the long axis direction. Next, as shown in FIG. 14, the free end 31 of the belt 3 is inserted into the returning slit 22. Finally, the hook and loop fastener areas are bonded to each other, and whereby it is possible to appropriately wind the winding equipment 10 around the subject to be wound having a very small outer diameter.

The operation of shortening the length of the belt 3 in the long axis direction can be appropriately performed according to the outer diameter of the rod-like body which is the subject to be wound.

If the anti-slip member 4 cannot be inserted into the winding slit 65 or the returning slit 22, the anti-slip member 4 is preliminarily removed from the free end 31 of the belt 3, and the anti-slip member 4 is attached to the belt 3 again, immediately before the hook and loop fastener areas are bonded to each other. This makes it possible to shorten the length of the belt 3 in the long axis direction

As shown in FIG. 13, in the case of using the movable bridge type guide and the unlinked type guide as the third guide 46, it is not necessary to remove the anti-slip member from the free end 31 of the belt 3. Therefore, it is possible to very efficiently remove the anti-slip member from the belt 3. Further, as shown in FIG. 14, it is unnecessary to attach a slip prevention device from the side of the free end 31 of the belt 3, and thus it is possible to attach the anti-slip member to the belt 3 very efficiently.

The mounted equipment 12, but is by no means limited to, a gripping means (for example, clip or pinches), a locking means (i.e. ring or hook), or a holding means (i.e. bag, drink holder, smartphone holder, mirror holder, or magnifying glass holder)

The base 1 and the mounted equipment 12 can be directly attached using known means or indirectly by using known connecting means.

The known connecting means include, but are by no means limited to, for example,

(1) a connecting means wherein a spherical body for connection is provided on the mounting surface 18 of the base 1, and a spherical storing room capable of storing the spherical body for connection is provided on the mounted equipment 12 (i.e. an end or a plate of the gripping means, an end or a plate of the locking means, or an end or a plate of the holding means), or
a connecting means wherein a spherical storing room is provided on the mounting surface 18 of the base 1, and a spherical body for connection that is stored in the spherical storing room for connection is provided on the mounted equipment 12 (for example, an end or a plate of the gripping means, an end or a plate of the locking means, or an end or a plate of the holding means),
(2) a connecting means wherein spherical bodies for connection are provided on both the mounting surface 18 of the base 1 and the mounted equipment 12, and the spherical bodies for connection are connected via a joint containing a spherical storing room for connection (for example, a cylindrical joint) (In connection to this, it is also possible to use a plurality of these joints and connect these joints to each other to form a rod-like body that can be bent at various angles), and
(3) a connecting means wherein at least one pair of locking small poles which are standing in parallel with each other from the surface of the mounting surface 18 of the base 1 (or flat plate bent into L shape) is provided on the mounting surface 18 of the base 1, and locking grooves capable of locking on the locking small poles (or flat plate bent into L shape) are provided on the mounted equipment 12 (i.e. a connecting means wherein the locking small poles or the flat plate bent into an L shape is locked while being slid into the locking grooves), or
a connecting means wherein at least one pair of locking small poles which are standing in parallel with each other (or flat plate bent into an L shape) is provided on the mounting surface 18, and the locking grooves capable of locking on the locking small poles (or a flat plate bent into an L shape) are provided on the mounting surface 18 of the base 1.

The object to be wound with the winding equipment containing the anti-slip fixture of the present invention is not limited as long as it can be wound by the base, the belt, and the anti-slip member included in the anti-slip fixture, but typically is a rod-like body. As the rod-like body, there may be mentioned, for example, various rod-like bodies inside the car, various rod-like bodies of a bicycle, various rod-like bodies of a baby buggy and a silver car (for example, side bars), various rod-like bodies in the home or the office.

Although the present invention has been described with reference to specific embodiments, various changes and modifications obvious to those skilled in the art are possible without departing from the scope of the appended claims.

### REFERENCE SIGNS LIST

1 . . . base;
3 . . . belt;
4 . . . anti-slip member;
10 . . . winding equipment;
11 . . . anti-slip fixture;
12 . . . mounted equipment;
14 . . . central portion;
16 . . . holding surface;
18 . . . mounting surface;
21 . . . binding bar;
22 . . . returning slit;
23 . . . returning bar;
24 . . . binding slit;
30 . . . binding end;
31 . . . free end;
32 . . . holding surface;
34 . . . bonded surface;
35 . . . first hook and loop fastener area;
36 . . . second hook and loop fastener area;
40 . . . plate;
40a . . . supporting surface;
40b . . . anti-slip surface;
42 . . . first guide;
42a . . . lateral surface;
42b . . . guide surface;
44 . . . second guide;
44a . . . lateral surface;
44b . . . guide surface;
46 . . . third guide;
46a . . . lateral surface;
46b . . . internal surface;
48 . . . opening for belt insertion;
50 . . . belt exposing opening;
50a . . . upstream exposure opening;
50b . . . downstream exposure opening;
52a . . . first bridge;
52b . . . second bridge;
55 . . . non-bonded region;
60 . . . subject to be wound;
62 . . . anti-slip part;
64 . . . winding bar;
65 . . . winding slit;
67 . . . locking means;
70 . . . holder for beverage container;
71 . . . winding tool;
72 . . . storage device;
73 . . . base;
74 . . . belt;
74a . . . binding end;
74b . . . free end;
74c . . . contacting surface;
74d . . . bonded surface;
74e . . . first hook and loop fastener area;
74f . . . second hook and loop fastener area;
75 . . . central portion;
75a . . . contacting surface;
76 . . . binding bar;
77 . . . returning slit;
79 . . . beverage container;
80 . . . rod-like body;
81 . . . supporting portion;

1. An anti-slip fixture comprising a base, a belt, and an anti-slip member, wherein the belt is inserted into the anti-slip member, characterized in that the base comprises
(1) a central portion comprising a holding surface, which is brought into direct or indirect contact with an object to be wound in a winding state, and a mounting surface for mounting a mounted equipment,
(2) a binding bar which is equipped adjacent to the central portion via a binding slit, for attaching the binding end of the belt, and
(3) a returning bar, which is equipped adjacent to the central portion via a returning slit on an opposite side of the binding bar,
the belt comprises
(1) a binding end attached to the binding bar of the base,
(2) a free end opposite to the binding end,
(3) a holding surface located on a surface side of the object to be wound in a winding state, and
(4) a bonded surface having a hook and loop fastener area on a surface opposite to the holding surface, and
the anti-slip member comprises
(1) an anti-slip surface which is brought into direct or indirect contact with the object to be wound in a winding state, and
(2) an opening for belt insertion through which the belt can be inserted.

2. The anti-slip fixture according to claim 1, further comprising an anti-slip part on the holding surface of the base.
